(19) United States
(12) Patent Application Publication
(10) Pub. No.: US 2021/0166202 A1
(43) Pub. Date: Jun. 3, 2021

(54) METHOD FOR MANAGING TIME-BASED CURRENCY

(71) Applicant: Ucarer Inc., Apia (WS)

(72) Inventors: Hung-Yi CHEN, Taipei City (TW); Shih-Yueh LIN, Taipei City (TW); Shih-Han LIU, Taipei City (TW)

(21) Appl. No.: 16/699,275

(22) Filed: Nov. 29, 2019

(51) Int. Cl. G06Q 20/06; H04L 9/06; G06Q 20/36; G06Q 20/32

(52) U.S. Cl. CPC G06Q 20/0652; G06Q 20/3276; G06Q 20/3676; H04L 9/0637

(57) ABSTRACT

A method for managing a time-based currency includes steps of: receiving a credit-issuance request containing a user identifier and a value K; based on the credit-issuance request, generating a credit-issuance instruction containing the value K and a user account corresponding to the user identifier; and sending the credit-issuance instruction to a blockchain system, in order for the blockchain system to generate a transaction record in the blockchain, the transaction record indicating that K number of time credits having a base time point corresponding to a time point when the transaction record is generated have been added to the user account.

### FIELD

The disclosure relates to management of a virtual currency, and more particularly to a method for managing a time-based virtual currency by using blockchain technology.

### BACKGROUND

Conventional virtual currencies that are managed by using blockchain technology, such as Bitcoin and Ether, do not have time limits for use, i.e., have no expiration dates, just like regular physical currencies. Due to the lack of time limits, many owners of these conventional virtual currencies are not active in using the conventional virtual currencies, so the usage rate and circulation rate of the conventional virtual currencies are both low, which is not good for the conventional virtual currencies.

### SUMMARY

Therefore, an object of the disclosure is to provide a method for managing a time-based currency that can alleviate at least one of the drawbacks of the prior art.

According to one aspect of the disclosure, a method for managing a time-based currency is to be implemented by an application server in communication with a blockchain system that is in association with a blockchain. The application server stores plural user identifiers that correspond respectively to plural users, and plural user accounts that are associated with the blockchain system and that correspond respectively to the user identifiers. The plural user identifiers include at least a first user identifier, and the plural user accounts include at least a first user account that is associated with the first user identifier. The method includes steps of: receiving a credit-issuance request that contains the first user identifier, and a value K; based on the credit-issuance request thus received, generating a credit-issuance instruction that contains the value K and the first user account; and sending the credit-issuance instruction thus generated to the blockchain system, in order for the blockchain system to generate, in response to receiving the credit-issuance instruction, a first transaction record in the blockchain, the first transaction record indicating that K number of time credits have been added to the first user account, the K number of time credits added to the first user account having a base time point that is related to an expiration time point of the K number of time credits and that is further related to a time point when the first transaction record is generated.

### BRIEF DESCRIPTION OF THE DRAWINGS

Other features and advantages of the disclosure will become apparent in the following detailed description of the embodiment (s) with reference to the accompanying drawings, of which:

FIG. 1 is a block diagram exemplarily illustrating a blockchain management system that can be utilized to perform a method for managing a time-based currency according to an embodiment of the disclosure;

FIG. 2 is a flow chart exemplarily illustrating a credit-issuance procedure according to an embodiment of the disclosure;

FIG. 3 is a flow chart exemplarily illustrating a credit-postponement procedure according to an embodiment of the disclosure;

FIG. 4 is a flow chart exemplarily illustrating another credit-postponement procedure according to an embodiment of the disclosure;

FIG. 5 is a flow chart exemplarily illustrating a currency-exchange procedure according to an embodiment of the disclosure; and

FIG. 6 is a flow chart exemplarily illustrating a credit-transfer procedure according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

The present disclosure discloses a method for managing a virtual currency (as opposed to physical currency) by using blockchain technology, wherein the virtual currency is a time-based currency and is time-limited. The time-limited characteristic may motivate users/owners to timely or frequently use the time-based virtual currency before expiration, thus avoiding low usage rate and low circulation rate as with the conventional virtual currencies. In addition, such timely/frequent use of the disclosed virtual currency may increase adhesion of the user to the virtual currency, and in turn further increase the usage rate of the virtual currency by the user.

The disclosed time-based currency may be related to care-giving or nursing. For example, population aging is one major concern for the government nowadays. In order to deal with the increasing demand for elderly care, governments are promoting a concept of time bank and time-based currency. That is, a volunteer caregiver may deposit the service time (in the form of, e.g., a time-based currency) that he/she has spent in giving care to others in a time bank. Afterwards, when the volunteer himself/herself needs to be taken care of, he/she may withdraw the service time from the time bank to exchange for care from other volunteers. The unit of the time-based currency may be termed time dollar, time credit, service credit, time coin, etc., in different countries/regions, and is referred to as “time credit” throughout this disclosure.

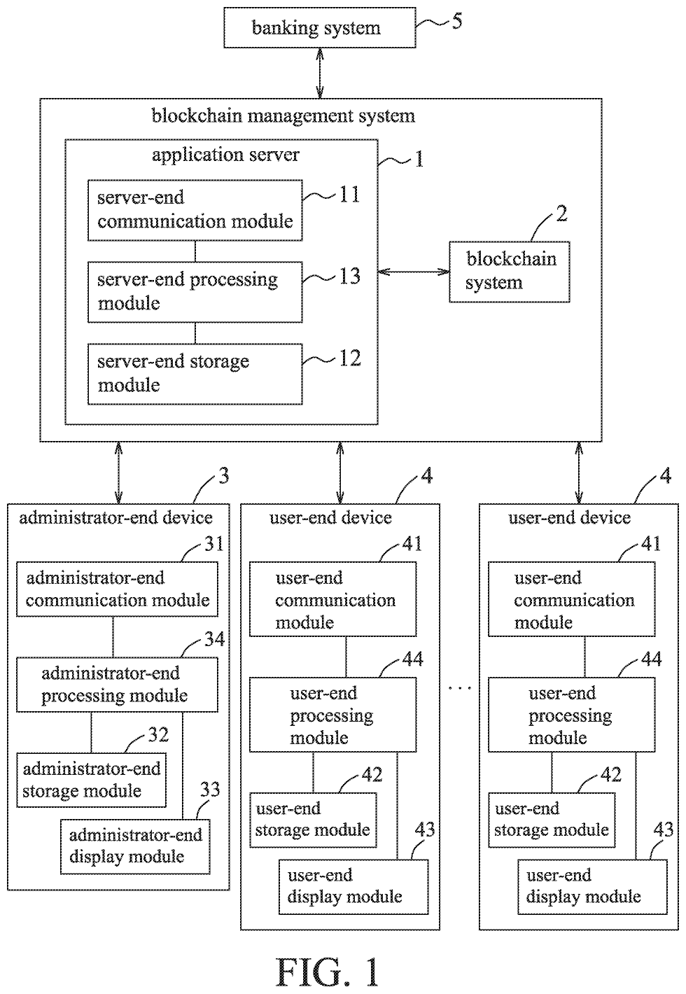

Referring to FIG. 1, a block diagram exemplarily illustrating a blockchain management system 100 that can be utilized to perform the method for managing a time-based currency according to an embodiment of the disclosure is depicted. The blockchain management system 100 includes an application server 1, and a blockchain system 2 in communication with the application server 1 through, for example, a communication network.

The application server 1 includes a server-end communication module 11, a server-end storage module 12, and a server-end processing module 13 electrically connected to the server-end communication module 11 and the server-end storage module 12. According to some embodiments, the application server 1 may be implemented as a personal computer, a server or a cloud host, but the disclosure is not limited thereto. As an example, the server-end communication module 11 is a network interface controller of the application server 1, the server-end storage module 12 is a hard disk drive or a solid state drive of the application server 1, and the server-end processing module 13 is a processor circuit of the application server 1. The server-end storage module 12 stores plural user identifiers that correspond respectively to plural users, plural user accounts that are associated with the blockchain system 2 and that correspond respectively to the user identifiers, and an administrator account associated with the blockchain system 2.

According to some embodiments, the blockchain system 2 may be implemented as multiple personal computers, a server or a cloud host, but the disclosure is not limited thereto. The blockchain system 2 is in association with a blockchain that records issuance and transaction of the time-based currency. According to an embodiment, each transaction record of the blockchain records issuance or transaction of the time-based currency, and indicates a base time point and a currency type of each time credit of the time-based currency that is related to the transaction record. The term “currency type” may be readily understood by drawing an analogy to the world of physical currencies, where U.S. dollar and European Euros, while both being physical currencies, are of two different currency types. The base time point of a time credit is related to an expiration time point of the time credit. According to some embodiments, the expiration time point of a time credit is a time point at an end of a predetermined time period that starts at the base time point of the time credit, wherein the predetermined time period may be dependent on the currency type of the time credit. For example, in a case that the predetermined time period for a particular currency type is two months, a time credit of the particular currency type that has a base time point of Mar. 1, 2020 would have an expiration time point of Apr. 30, 2020.

The blockchain management system 100, specifically the application server 1, is in communication with a banking system 5 through, for example, a communication network. According to some embodiments, the banking system 5 may be implemented as a server or a cloud host, but the disclosure is not limited thereto.

The blockchain management system 100 is also in communication with an administrator-end device 3 and plural user-end devices 4 (exempiarily illustrated as two user-end devices 4 in FIG. 1) through, for example, at least one communication network. As shown in FIG. 1, the administrator-end device 3 includes an administrator-end communication module 31, an administrator-end storage module 32, an administrator-end display module 33 and an administrator-end processing module 34 electrically connected to the administrator-end communication module 31, the administrator-end storage module 32 and the administrator-end display module 33. Each user-end device 4 includes a user-end communication module 41, a user-end storage module 42, a user-end display module 43 and a user-end processing module 44 electrically connected to the user-end communication module 41, the user-end storage module 42 and the user-end display module 43. According to some embodiments, each of the administrator-end device 3 and the user-end devices 4 may be implemented as a smart mobile device, a tablet or a personal computer, but the disclosure is not limited thereto.

For example, each of the administrator-end communication module 31 and the user-end communication module 41 may include a mobile communicating module supporting telecommunication using Long-Term Evolution (LTE), the third generation (3G) and/or fourth generation (4G) of wireless mobile telecommunications technology, and/or the like. Each of the administrator-end storage module 32 and the user-end storage module 42 may be embodied using a flash memory or other non-transitory storage medium. Each of the administrator-end display module 33 and the user-end display module 43 is a display. Each of the administrator-end processing module 34 and the user-end processing module 44 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc.

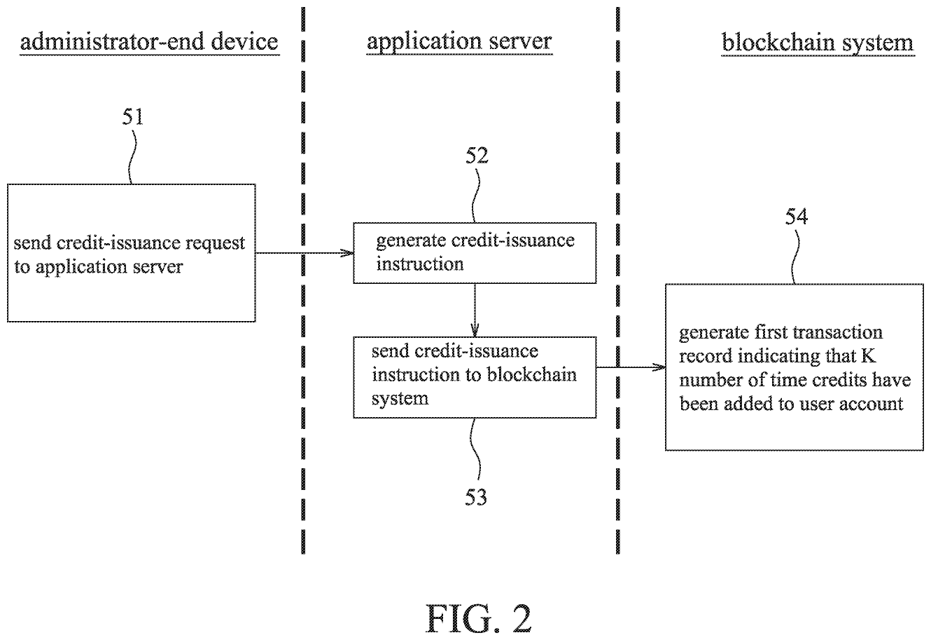

Detailed operations of the method for managing the time-based currency, including a credit-issuance procedure, a credit-postponement procedure, a currency-exchange procedure and a credit-transfer procedure, are depicted in FIGS. 2-6, and the following description of the method is given with reference to the system and devices depicted in FIG. 1.

Referring to FIG. 2, the credit-issuance procedure for issuing time credits to a user account is illustrated. The credit-issuance procedure includes steps 51-54.

In step 51, the administrator-end device 3 generates a credit-issuance request and sends the same to the application server 1. The credit-issuance request contains a user identifier corresponding to a user of one of the plural user-end devices 4, and a value K indicating a number of time credits of the time-based currency to be added to a user account of the user, wherein the value K is not less than one. According to some embodiments, the credit-issuance request may further contain a designated currency type for the K number of time credits to be added to the user account.

In step 52, the application server 1 receives the credit-issuance request from the administrator-end device 3 through the server-end communication module 11, and then, based on the credit-issuance request, generates a credit-issuance instruction that contains the value K contained in the credit-issuance request and the user account of the user which corresponds to the user identifier contained in the credit-issuance request. In a case that the received credit-issuance request contains a designated currency type, the credit-issuance instruction may further include the designated currency type.

In step 53, the application server 1 sends the credit-issuance instruction generated in step 52 to the blockchain system 2 through the server-end communication module 11.

In step 54, in response to receiving the credit-issuance instruction from the application server 1, the blockchain system 2 generates a first transaction record in the blockchain. The first transaction record indicates that K number of time credits have been added to the user account, wherein each of the K number of time credits added to the user account has a base time point related to a time point when the first transaction record is generated, and has a currency type as indicated in the credit-issuance instruction (if the received credit-issuance instruction contains a designated currency type) or a default currency type (if the received credit-issuance instruction does not contain a designated currency type). According to some embodiments, the base time is exactly the time point when the first transaction record is generated.

Alterations may be made to the credit-issuance procedure illustrated in FIG. 2. For example, in another embodiment, the administrator-end device 3 does not generate and send the credit-issuance request to the application server 1 in step 51. Instead, a service notification may be sent from the administrator-end device 3 or one of the user-end devices 4, wherein the service notification contains a user identifier corresponding to a user who has provided, for example, a care service, and further contains a start time point of the care service, and an end time point of the care service. Then, the application server 1 receives the service notification from the administrator-end device 3 or the one of the user-end devices 4, and generates the credit-issuance instruction containing a user account corresponding to the user identifier contained in the service notification, and a value K (i.e., the number of time credits rewarded for the care service provided) that is calculated based on the start and end time points contained in the service notification (e.g., based on a service time duration calculated from the start and end time points) .

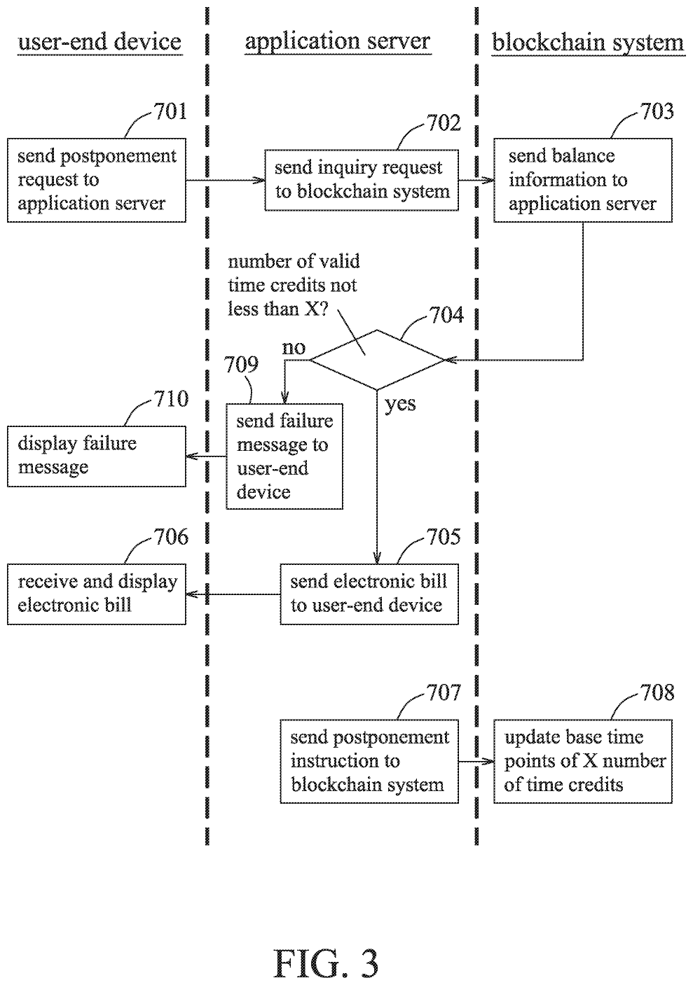

Referring to FIG. 3, the credit-postponement procedure for postponing expiration time points of time credits is illustrated. The credit-postponement procedure includes steps 701-711.

In step 701, one of the user-end devices 4 generates a postponement request, and sends the same to the application server 1 through the user-end communication module 41 thereof. The postponement request contains a user identifier corresponding to a user possessing the one of the user-end devices 4, and a value X indicating a number of time credits, of each of which the base time point (or the expiration time point) is to be postponed, wherein the value X is not less than one. According to some embodiments, the postponement request may further contain a designated currency type for the X number of time credits to be postponed.

In step 702, after receiving the postponement request from the one of the user-end devices 4, the application server 1 generates an inquiry request, and sends the inquiry request to the blockchain system 2 through the server-end communication module 11. The inquiry request contains a user account corresponding to the user identifier contained in the postponement request.

In step 703, in response to receiving the inquiry request from the application server 1, the blockchain system 2 generates balance information based on all transaction records in the blockchain that are associated with the user account contained in the inquiry request, and then sends the balance information to the application server 1. The balance information includes the base time point of each time credit in said user account. According to some embodiments, the balance information may further include the currency type of each time credit in the user account. According to some embodiments, each unspent transaction output (UTXO) in the blockchain may have been tagged with a metadata indicating a corresponding base time point of the UTXO, and the balance information may be generated by retrieving the UTXOs that are related to the user account.

In step 704, the application server 1 receives the balance information from the blockchain system 2, and determines, based on the received balance information, whether a number of those of the time credits in the user account, the expiration time point of each of which is not before a current time point, is not less than the value X, namely, whether a number of valid, or un-expired time credits in the user account is not less than the value X. If the determination made in step 704 is affirmative (i.e., the number of valid time credits in the user account is not less than the value X) , the process goes to step 705; otherwise, the process goes to step 709. According to some embodiments, in a case that the postponement request the application server 1 received in step 702 contains the designated currency type for the X number of time credits, the process goes to step 705 only when a number of valid time credits in the user account, the currency type of each of which is the designated currency type, is not less than the value X.

In step 709, the application server 1 generates a failure message indicating that the user account does not have enough valid time credits that can be postponed for a credit-postponement transaction requested by the postponement request, and sends the failure message to the one of the user-end devices 4 through the server-end communication module 11.

In step 710, the one of the user-end devices 4 receives the failure message from the application server 1 through the user-end communication module 41 thereof, and displays the failure message on the one of the user-end devices 4 through the user-end display module 43 thereof.

In step 705, the application server 1 generates an electronic bill, and sends the same to the one of the user-end devices 4 through the server-end communication module 11. The electronic bill corresponds to the user identifier contained in the received postponement request, and contains an identification code related to payment of the electronic bill. In an embodiment, the billing amount of the electronic bill is dependent on the value X. According to some embodiments, the electronic bill may have a valid time period. According to some embodiments, the identification code contained in the electronic bill may be a one-dimensional barcode or a two-dimensional barcode, but the disclosure is not limited thereto.

In step 706, the one of the user-end devices 4 receives the electronic bill from the application server 1 through the user-end communication module 41 thereof, and displays the electronic bill (including the identification code) on the one of the user-end devices 4 through the user-end display module 43 thereof. After receiving the electronic bill, the user possessing the one of the user-end devices 4 may make a payment to settle the electronic bill by using the identification code contained in the electronic bill. In a case that the electronic bill has a valid time period, the payment can only be made within the valid time period. According to some embodiments, the payment may be made, for example, by scanning the identification code using a point of sale (POS) device at a convenient store. When the payment for settling the electronic bill is completed, the application server 1 will receive a payment notification indicating completion of the payment of the electronic bill from the banking system 5.

In step 707, after receiving the payment notification from the banking system 5, the application server 1 generates a postponement instruction and sends the same to the blockchain system 2. The postponement instruction contains the user account corresponding to the user identification contained in the postponement request received in step 702, the value X, and a postponed time point that is later than the base time points of the X number of time credits to be postponed. According to some embodiments, in a case that the postponement request received in step 702 contains a designated currency type for the X number of time credits to be postponed, the postponement instruction generated and sent in step 707 may further contain the designated currency type contained in the received postponement request.

In step 708, the blockchain system 2 receives the postponement instruction from the application server 1, and updates the base time points respectively of the X number of time credits of said user account to each be equal to the postponed time point contained in the received postponement instruction by creating a transaction. Specifically, the input of the transaction is at least one of the UTXOs that are associated with said user account, wherein the at least one of the UTXOs associated with said user account collectively represents an S number of time credits each having an expiration time point not before the current time point, and S is not less than X. Further, the output of the transaction includes a UTXO representing the X number of time credits each having a base time point equal to the postponed time point, and also, when S is greater than X, another UTXO representing an S-X number of time credits each having a base time point the same as that of one of the at least one inputted UTXO. It should be noted that a transaction record indicating the transaction created in step 708 is also generated in the blockchain.

In some embodiments, the X number of time credits are X number of valid time credits having the earliest base time points out of all valid time credits in said user account (i.e., the first X number of valid time credits in said user account if the time credits are arranged in chronological order of the base time points). For example, continuing with the UXTO approach mentioned above, if x is 50 and the user account is associated with three UTXOs including a first UTXO of 30 valid time credits having a base time point of T1, a second UTXO of 40 valid time credits having a base time point of T2 and a third UTXO of 10 valid time credits having a base time point of T3, wherein T2 is later than T1, and T3 is later than T2, the transaction created will have the first and second UTXOs as its inputs and two new UTXOs as its outputs. Specifically, one of the two new UTXOs represents 50 time credits having a base time point equal to the postponed time point, and the other of the two new UTXOs represents 20 time credits having a base time point of T2.

According to some embodiments, in a case that the received postponement instruction contains a designated currency type, the X number of time credits whose base time points are updated are of the designated currency type. According to some advanced embodiments, in a case that the received postponement instruction contains a designated currency type, the X number of time credits whose base time points are updated are the first X number of valid time credits with earliest base time points whose currency type is the designated currency type.

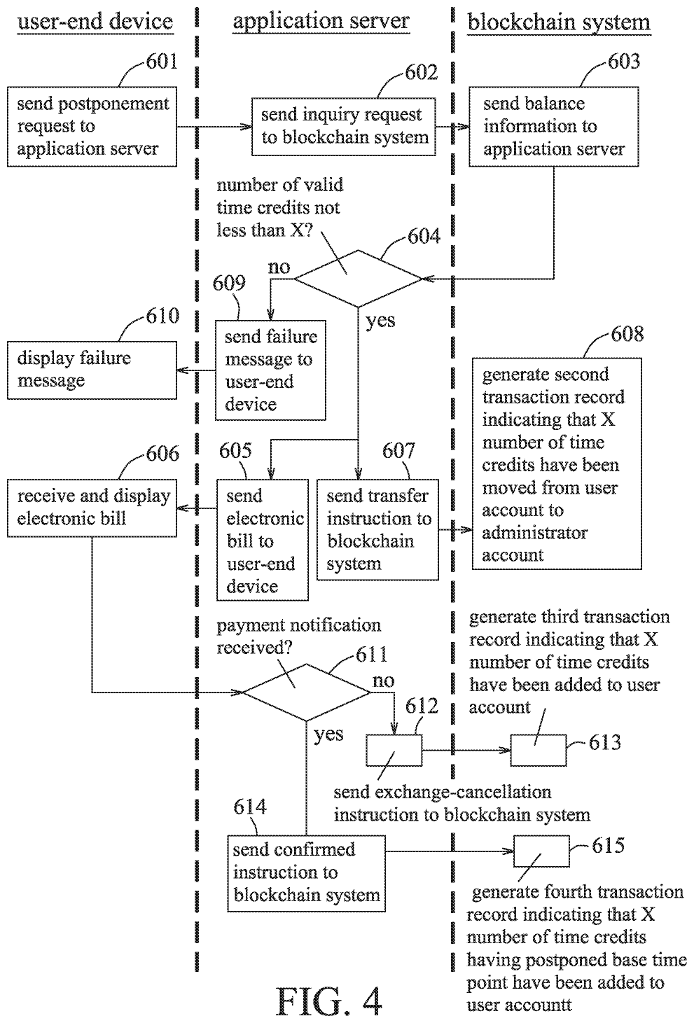

Referring to FIG. 4, another credit-postponement procedure for postponing expiration time points of time credits is illustrated. The another credit-postponement procedure includes steps 601-615, wherein steps 601-606, 609 and 610 are similar to steps 701-706, 709 and 710 of FIG. 3, respectively, and descriptions thereof are not repeated below.

In the credit-postponement procedure of FIG. 4, step 607 is performed in addition to step 605 when the determination result of step 604 is affirmative. Step 606 may be performed before, after or simultaneously as step 605. It should be noted that, although the electronic bill generated in step 705 of FIG. 3 may optionally have a valid time period, the electronic bill generated in step 605 of FIG. 4 must have a valid time period.

In step 607, the application server 1 generates a transfer instruction and sends the same to the blockchain system 2. The transfer instruction contains the value X, the user account corresponding to the user identifier contained in the postponement request received in step 602, and the administrator account associated with the blockchain system 2. According to some embodiments, in a case that the postponement request received in step 602 contains the designated currency type for the X number of time credits, the transfer instruction may further contain the designated currency type.

In step 608, in response to receiving the transfer instruction from the application server 1, the blockchain system 2 generates a second transaction record in the blockchain. The second transaction record indicates that X number of time credits have been moved from said user account to the administrator account, wherein the X number of time credits moved from said user account to the administrator account are first X valid time credits having the earliest base time points out of all valid the time credits in said user account. According to some embodiments, in a case that the received transfer instruction contains the designated currency type, the second transaction record indicates that X number of time credits are moved from said user account to the administrator account, wherein the X number of time credits moved to the administrator account are first X time credits having the earliest base time points out of all the time credits in said user account with unexpired expiration time points and the designated currency type.

Turning to step 611 following step 606, the application server 1 determines whether a payment notification from the banking system 5 that corresponds to the electronic bill generated and sent to the one of the user-end devices 4 in step 605 is received within the valid time period of the electronic bill. If the determination made in step 611 is affirmative, the process goes to step 614; otherwise, the process goes to step 612.

In step 612, the application server 1 generates a postponement-cancellation instruction and sends the same to the blockchain system 2. The postponement-cancellation instruction contains the value X, said user account and the administrator account. According to some embodiments, in a case that the postponement request received in step 602 contains the designated currency type, the postponement-cancellation instruction may further contain the designated currency type.

In step 613, in response to receiving the postponement-cancellation instruction from the application server 1, the blockchain system 2 generates a third transaction record in the blockchain. The third transaction record indicates that X number of time credits have been added to said user account and respectively have the base time points of the X time credits that were previously moved from said user account to the administrator account. According to some embodiments, in a case that the received postponement-cancellation instruction contains the designated currency type, the third transaction record further indicates that the X number of time credits added to said user account are of the designated currency type.

In step 614, the application server 1 generates a confirmed instruction, and sends the same to the blockchain system 2 through the server-end communication module 11. The confirmed instruction contains said user account, the value X, and a postponed time point that is later than the base time points of the X number of time credits to be postponed. According to some embodiments, in a case that the postponement request received in step 602 contains a designated currency type of the X number of time credits to be postponed, the confirmed instruction may further contain the designated currency type contained in the received postponement request.

In step 615, in response to receiving the confirmed instruction from the application server 1, the blockchain system 2 generates a fourth transaction record in the blockchain. The fourth transaction record indicates that X number of time credits having a postponed base time point (i.e., a base time point equal to the postponed time point contained in the confirmed instruction) have been added to said user account, and the currency type of the X number of time credits is the same as the currency type of the X number of time credits that were moved from said user account to the administrator account in step 608.

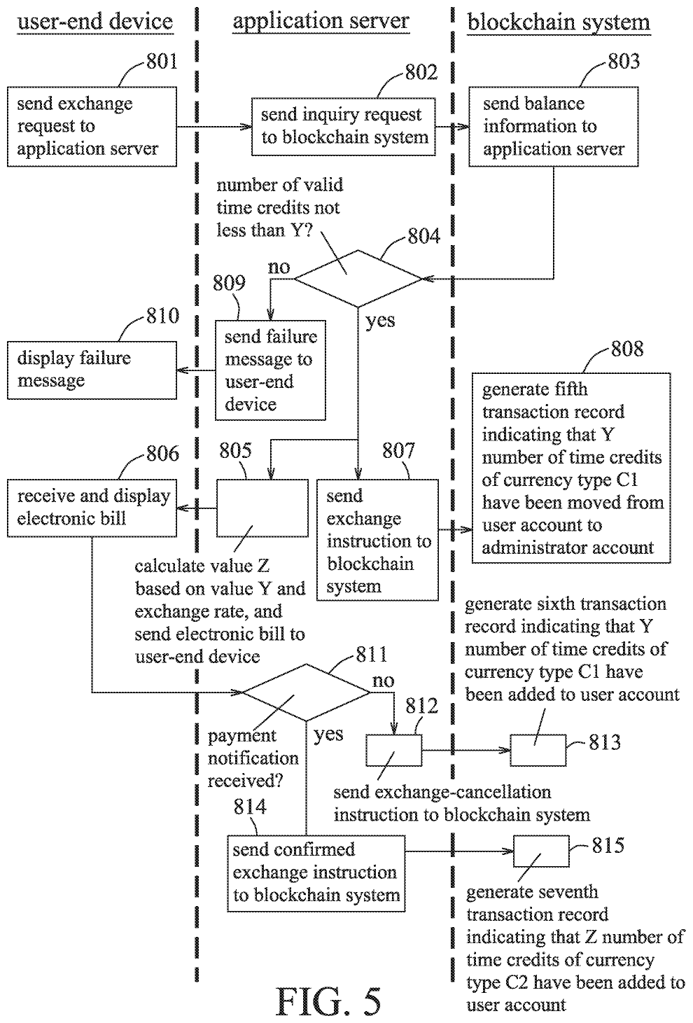

Referring to FIG. 5, a currency-exchange procedure for changing time credits of one currency type into time credits of another currency type is illustrated. The currency-exchange procedure includes steps 801-815.

In step 801, one of the user-end devices 4 generates an exchange request, and sends the same to the application server 1 through the user-end communication module 41 thereof. The exchange request contains a user identifier corresponding to a user possessing the one of the user-end devices 4, a value Y indicating a number of time credits to be exchanged, and a currency type C1 of the Y number of time credits to be exchanged, wherein the value Y is not less than one. According to some embodiments, the exchange request may further contain a currency type C2, which the Y number of time credits are to be exchanged to.

In step 802, after receiving the exchange request from the one of the user-end devices 4, the application server 1 generates an inquiry request, and sends the inquiry request to the blockchain system 2 through the server-end communication module 11. The inquiry request contains a user account corresponding to the user identifier contained in the exchange request.

In step 803, in response to receiving the inquiry request from the application server 1, the blockchain system 2 generates balance information based on all transaction records in the blockchain that are associated with the user account contained in the inquiry request, and sends the balance information to the application server 1. The balance information includes the base time point and the currency type of each time credit in the user account.

In step 804, the application server 1 receives the balance information from the blockchain system 2, and determines, based on the received balance information, whether a number of those of the time credits in the user account, the currency type of each of which is the currency type C1 and the expiration time point of each of which is not before a current time point, is not less than the value Y. If so, the process goes to steps 805 and 807; otherwise, the process goes to step 809.

In step 809, the application server 1 generates a failure message indicating that the user account does not have enough valid time credits that can be exchanged for an exchange transaction requested by the exchange request, and sends the failure message to the one of the user-end devices 4 through the server-end communication module 11.

In step 810, the one of the user-end devices 4 receives the failure message from the application server 1 through the user-end communication module 41 thereof, and displays the failure message on the one of the user-end devices 4 through the user-end display module 43 thereof.

In step 807, the application server 1 generates an exchange instruction and sends the same to the blockchain system 2. The exchange instruction contains the value Y, the currency type C1, the user account corresponding to the user identifier contained in the exchange request received in step 802, and the administrator account associated with the blockchain system 2.

In step 808, in response to receiving the exchange instruction from the application server 1, the blockchain system 2 generates a fifth transaction record in the blockchain. The fifth transaction record indicates that Y number of time credits of the currency type C1 have been moved from said user account to the administrator account, wherein the Y number of time credits moved to the administrator account are first Y time credits having the earliest base time points out of all the time credits in said user account, the expiration time point of each of which is not before the current time point, and the currency type of each of which is the currency type C1.

In step 805, the application server 1 calculates a value Z based on the value Y and an exchange rate from the currency type C1 to the currency type C2. The application server 1 further generates an electronic bill having a valid time period, and sends the same to the one of the user-end devices 4 through the server-end communication module 11. The electronic bill corresponds to the user identifier contained in the received exchange request, and contains an identification code related to payment of the electronic bill. In an embodiment, the billing amount of the electronic bill is dependent on the value Z. According to some embodiments, the identification code contained in the electronic bill may be a one-dimensional barcode or a two-dimensional barcode, but the disclosure is not limited thereto.

In step 806, the one of the user-end devices 4 receives the electronic bill from the application server 1 through the user-end communication module 41 thereof, and displays the electronic bill (including the identification code) on the one of the user-end devices 4 through the user-end display module 43 thereof. Similar to the electronic bills in the credit-postponement procedure of FIGS. 3 and 4, the user possessing the one of the user-end devices 4 may make a payment to settle the electronic bill thus received by scanning the identification code contained in the electronic bill within the valid time period of said electronic bi 11, for example, using a point of sale (POS) device at a convenient store. When the payment for settling said electronic bill is completed, the banking system 5 will be informed, and will send a payment notification indicating completion of the payment of the electronic bill to the application server 1, too. Step 807 may be performed before, after or simultaneously as step 805.

In step 811, the application server 1 determines whether a payment notification from the banking system 5 that corresponds to the electronic bill sent to the one of the user-end devices 4 in step 805 is received within the valid time period of the electronic bill. If the determination made in step 811 is affirmative, the process goes to step 814; otherwise, the process goes to step 812.

In step 812, the application server 1 generates an exchange-cancellation instruction and sends the same to the blockchain system 2. The exchange-cancellation instruction contains the value Y, the currency type C1, said user account and the administrator account.

In step 813, in response to receiving the exchange-cancellation instruction from the application server 1, the blockchain system 2 generates a sixth transaction record in the blockchain. The sixth transaction record indicates that Y number of time credits of the currency type C1 have been added to said user account and respectively have the base times of the Y time credits that were previously moved from said user account to the administrator account in step 808.

In step 814, the application server 1 generates a confirmed exchange instruction, and sends the same to the blockchain system 2 through the server-end communication module 11. The confirmed exchange instruction contains said user account, the another currency type C2 and the value Z.

In step 815, in response to receiving the confirmed exchange instruction from the application server 1, the blockchain system 2 generates a seventh transaction record in the blockchain. The seventh transaction record indicates that Z number of time credits of the another currency type C2 have been added to said user account, and each of the Z number of time credits has a base time point corresponding to a time point when the seventh transaction record is generated.

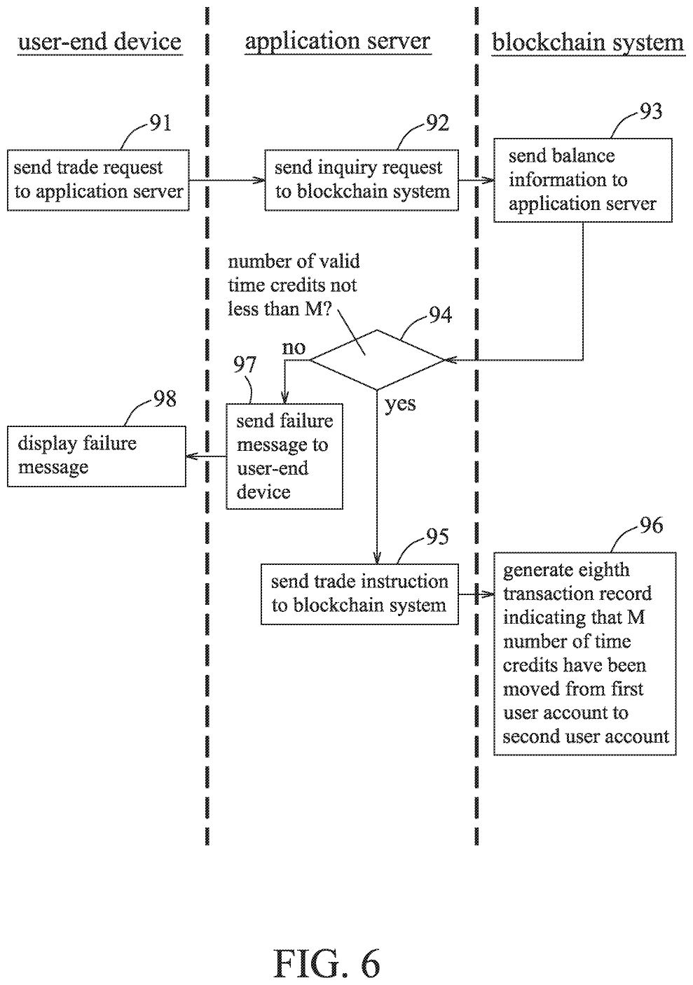

Referring to FIG. 6, a credit-transfer procedure for transferring time credits from a first user's account to a second user's account that may be performed due to, for example, a trade made with time credits is illustrated. The credit-transfer procedure includes steps 91-98.

In step 91, one of the user-end devices 4 generates a trade request, and sends the same to the application server 1 through the user-end communication module 41 thereof. The trade request contains a value M indicating a number of time credits to be traded, a first user identifier corresponding to a first user possessing the one of the user-end devices 4, and a second user identifier corresponding to a second user to which the first user intends to give the time credits, wherein the value M is not less than one. According to some embodiments, the trade request may further contain a designated currency type of the M number of time credits to be transferred.

In step 92, after receiving the trade request from the one of the user-end devices 4, the application server 1 generates an inquiry request, and sends the inquiry request to the blockchain system 2 through the server-end communication module 11. The inquiry request contains a first user account corresponding to the first user identifier contained in the trade request.

In step 93, in response to receiving the inquiry request from the application server 1, the blockchain system 2 generates balance information based on all transaction records in the blockchain that are associated with the first user account contained in the inquiry request, and then sends the balance information to the application server 1. The balance information includes the base time point of each time credit in the first user account. According to some embodiments, the balance information may further include the currency type of each time credit in the first user account.

In step 94, the application server 1 receives the balance information from the blockchain system 2, and determines, based on the received balance information, whether a number of valid, un-expired time credits in the first user account is not less than the value M. If the determination made in step 94 is affirmative, the process goes to step 95; otherwise, the process goes to step 97. According to some embodiments, in a case that the trade request the application server 1 received in step 92 contains a designated currency type of the M number of time credits, the process goes to step 95 only when a number of valid time credits in the first user account with the designated currency type is not less than the value M.

In step 97, the application server 1 generates a failure message indicating that the first user account does not have enough valid time credits that can be traded for a trade transaction requested by the trade request, and sends the failure message to the one of the user-end devices 4 through the server-end communication module 11.

In step 98, the one of the user-end devices 4 receives the failure message from the application server 1 through the user-end communication module 41 thereof, and displays the failure message on the one of the user-end devices 4 through the user-end display module 43 thereof.

In step 95, the application server 1 generates a trade instruction, and sends the same to the blockchain system 2 through the server-end communication module 11. The trade instruction contains the value M, the first user account, and a second user account corresponding to the second user identifier contained in the trade request received in step 92. In a case that the received trade request contains a designated currency type, the trade instruction may further include the designated currency type. It should be noted that the first and second user identifiers are among the plural user identifiers stored in the server-end storage module 12, and the first and second user accounts are among the plural user accounts stored in the server-end storage module 12.

In step 96, in response to receiving the trade instruction, the blockchain system 2 generates an eighth transaction record in the blockchain. The eighth transaction record indicates that the M number of time credits have been moved from the first user account to the second user account. According to some embodiments, the eighth transaction record may include a first record indicating that M number of time credits have been removed from the first user account, and a second record indicating that M number of time credits, each of which has a base time point corresponding to a time point when the blockchain system 2 received the trade instruction, have been added to the second user account. It should be noted that the M number of time credits that have been removed from the first user account are not equivalent to the M number of time credits that have been added to the second user account because the base time points of the M number of time credits that have been added to the second user account are specifically designated to correspond to the time point when the blockchain system 2 received the trade instruction. In some embodiments, the M number of time credits removed from the first user account are the first M number of valid time credits having the earliest base time points out of all the valid time credits in the first user account. According to some advanced embodiments, in a case that the received trade instruction contains a designated currency type, the M number of time credits moved from the first user account to the second user account, or the M number of time credits removed from the first user account, or the M number of time credits added to the second user account are of the designated currency type.

According to some embodiments, step 91 may be performed in response to the first user confirming via, for example, an application installed on the one of the user-end devices A (referred to as first user-end device A hereinafter) that a corresponding care service provided by the second user has been completed. Specifically, when the first user intends to use his/her time credits to buy or exchange for a certain care service, the first user may first generate an appointment request containing the value M, the currency type of the time credits to be used (i.e., the designated currency type), appointment time for the required care service and conditions/requirements concerning the required care service, and then send the appointment request to the application server 1 through the user-end communication module 41 of the first user-end device 4 via the application. In response to receiving the appointment request, the application server 1 may send to the blockchain system 2 an inquiry request for balance information of the first user account, receive the requested balance information from the blockchain system 2, and determine, based on the received balance information, whether the first user possesses enough valid time credits (i.e., whether there are M number of time credits of the designated currency type in the first user account, the expiration time point of each of which is not before the appointment time) to pay for the requested appointment (similar to steps 92-94). When the application server 1 determines that the first user possesses enough valid time credits to pay for the requested appointment, the application server 1 may announce the appointment request for other users to review. The second user may accept the appointment request via an application installed on a second user-end device 4 that he/she possesses. After the second user has provided the care service as the appointment request requires, the second user may send an appointment-completed notification (containing information of the first user or the first user identifier) to the application server 1 via the application executed on the second user-end device 4. The application server 1 may then forward the appointment-completed notification to the first user-end device 4 for the first user to confirm.

In comparison to conventional virtual currencies managed by using block technology, such as Bitcoin or Ether, the disclosed time-based virtual currency with the time-limited characteristic is less fungible (one Bitcoin is equivalent to any other one Bitcoin, but one time credit is not necessarily equivalent to another time credit due to possible difference in the base time points thereof), and requires management different from, e.g., Bitcoin or Ether.

As mentioned above, the disclosed time-based virtual currency is beneficial in that the time-limited characteristic of the disclosed time-based virtual currency enhances its usage rate and circulation rate. Therefore, the disclosed method for managing said time-based currency not only helps to realize the abovementioned concept of time bank and time currency, but also improves circulation rate of the time currency and adhesion of users to the time currency.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for managing a time-based currency to be implemented by an application server in communication with a blockchain system that is in association with a blockchain, the application server storing plural user identifiers that correspond respectively to plural users, and plural user accounts that are associated with the blockchain system and that correspond respectively to the user identifiers, the plural user identifiers including at least a first user identifier, the plural user accounts including at least a first user account that is associated with the first user identifier, the method comprising steps of:
receiving a credit-issuance request that contains the first user identifier, and a value K;
based on the credit-issuance request thus received, generating a credit-issuance instruction that contains the value K and the first user account; and
sending the credit-issuance instruction thus generated to the blockchain system, in order for the blockchain system to generate, in response to receiving the credit-issuance instruction, a first transaction record in the blockchain, the first transaction record indicating that K number of time credits have been added to the first user account, the K number of time credits added to the first user account having a base time point that is related to an expiration time point of the K number of time credits and that is further related to a time point when the first transaction record is generated.

2. The method of claim 1, the application server being further in communication with a user-end device, the plural user identifiers including a second user identifier that corresponds to a user possessing the user-end device, the plural user accounts including a second user account that corresponds to the second user identifier, the method further comprising steps of:
receiving, from the user-end device, a postponement request that contains the second user identifier and a value X;
based on the postponement request thus received, generating an inquiry request that contains the second user account;
sending the inquiry request thus generated to the blockchain system, in order for the blockchain system to generate, in response to receiving the inquiry request, balance information based on all transaction records in the blockchain that are associated with the second user account and to send the balance information to the application server, the balance information including a base time point of each time credit in the second user account, the base time point of each time credit being related to an expiration time point of the time credit;
after receiving the balance information from the blockchain system, determining, based on the balance information thus received, whether a number of those of the time credits in the second user account, the expiration time point of each of which is not before a current time point, is not less than the value X;
when it is determined that the number of those of the time credits in the second user account is not less than the value X, generating an electronic bill that corresponds to the second user identifier and that contains an identification code related to payment of the electronic bill;
sending the electronic bill thus generated to the user-end device;
after receiving a payment notification corresponding to the electronic bill, sending a postponement instruction containing the second user account, the value X, and a postponed time point to the blockchain system, in order for the blockchain system to generate, in response to receiving the postponement instruction, a second transaction record and a third transaction record in the blockchain, the second transaction record indicating that X number of time credits have been removed from the second user account, the third transaction record indicating that X number of time credits having a base time point equal to the postponed time point contained in the postponement instruction have been added to the second user account, the postponed time point being later than the base time points of the X number of time credits that have been removed from the second user account as indicated in the second transaction record.

3. The method of claim 2, wherein the identification code contained in the electronic bill is one of a one-dimensional barcode and a two-dimensional barcode.

4. The method of claim 1, the application server being further in communication with a user-end device, the plural user identifiers including a second user identifier that corresponds to a user possessing the user-end device, the plural user accounts including a second user account that corresponds to the second user identifier, the method further comprising steps of:
receiving, from the user-end device, a postponement request that contains the second user identifier and a value X;
based on the postponement request thus received, generating an inquiry request that contains the second user account;
sending the inquiry request thus generated to the blockchain system, in order for the blockchain system to generate, in response to receiving the inquiry request, balance information based on all transaction records in the blockchain that are associated with the second user account and to send the balance information to the application server, the balance information including a base time point of each time credit in the second user account, the base time point of each time credit being related to an expiration time point of the time credit;
after receiving the balance information from the blockchain system, determining, based on the balance information thus received, whether a number of those of the time credits in the second user account, the expiration time point of each of which is not before a current time point, is not less than the value X;
when it is determined that the number of those of the time credits in the second user account is not less than the value X, generating an electronic bill that corresponds to the second user identifier and that contains an identification code related to payment of the electronic bill;
sending the electronic bill thus generated to the user-end device;
when it is determined that the number of those of the time credits in the second user account is not less than the value X, generating a transfer instruction containing the value X, the second user account, and an administrator account associated with the blockchain system;
sending the transfer instruction thus generated to the blockchain system, in order for the blockchain system to generate, in response to receiving the transfer instruction, a second transaction record in the blockchain, the second transaction record indicating that X number of time credits have been moved from the second user account to the administrator account;
when a payment notification corresponding to the electronic bill is received by the application server, sending a confirmed instruction containing the second user account, the value X and a postponed time point to the blockchain system, in order for the blockchain system to generate, in response to receiving the confirmed instruction, a third transaction record in the blockchain, the third transaction record indicating that X number of time credits having a base time point equal to the postponed time point have been added to the second user account, the postponed time point being later than the base time points of the X number of time credits that have been moved from the second user account to the administrator account as indicated in the second transaction record.

5. The method of claim 4, wherein the identification code contained in the electronic bill is one of a one-dimensional barcode and a two-dimensional barcode.

6. The method of claim 4, wherein the step of sending the transfer instruction includes:
sending the transfer instruction thus generated to the blockchain system, in order for the blockchain system to generate, in response to receiving the transfer instruction, the second transaction record in the blockchain, the second transaction record indicating that the X number of time credits moved from the second user account to the administrator account are first X time credits having the earliest base time points out of all the time credits in the second user account, the expiration time point of each of which is not before the current time point.

7. The method of claim 4, the electronic bill sent to the user-end device having a valid time period, the method further comprising step of:
when no payment notification corresponding to the electronic bill is received by the application server during the valid time period, sending a postponement-cancellation instruction to the blockchain system, in order for the blockchain system to generate, in response to receiving the postponement-cancellation instruction, a fourth transaction record in the blockchain, the fourth transaction record indicating that X number of time credits have been added to the second user account and respectively have the base time points of the X number of time credits that were previously moved from the second user account to the administrator account.

8. The method of claim 1, wherein the step of sending the credit-issuance instruction includes:
sending the credit-issuance instruction thus generated to the blockchain system, in order for the blockchain system to generate, in response to receiving the credit-issuance instruction, the first transaction record further indicating a currency type of the K number of time credits added to the first user account.

9. The method of claim 8, the application server being further in communication with a user-end device, the plural user identifiers including a second user identifier that corresponds to a user possessing the user-end device, the plural user accounts including a second user account that corresponds to the second user identifier, the method further comprising steps of:
receiving, from the user-end device, an exchange request that contains a value Y, a currency type C1 and the second user identifier;
based on the exchange request thus received, generating an inquiry request that contains the second user account;
sending the inquiry request thus generated to the blockchain system, in order for the blockchain system to generate, in response to receiving the inquiry request, balance information based on ail transaction records in the blockchain that are associated with the second user account and to send the balance information to the application server, the balance information including a base time point and a currency type of each time credit in the second user account, the base time point of each time credit being related to an expiration time point of the time credit;
after receiving the balance information from the blockchain system, determining, based on the balance information thus received, whether a number of those of the time credits in the second user account, the currency type of each of which is the currency type C1 and the expiration time point of each of which is not before a current time point, is not less than the value Y; and
when it is determined that the number of those of the time credits in the second user account is not less than the value Y,
calculating a value Z based on the value Y and an exchange rate from the currency type C1 to another currency type C2,
generating an electronic bill that corresponds to the second user identifier and that contains an identification code related to payment of the electronic bill,
generating an exchange instruction containing the value Y, the currency type C1, the second user account, and an administrator account associated with the blockchain system,
sending the electronic bill thus generated to the user-end device, sending the exchange instruction thus generated to the blockchain system, in order for the blockchain system to generate, in response to receiving the exchange instruction, a second transaction record in the blockchain, the second transaction record indicating that Y number of time credits of the currency type C1 have been moved from the second user account to the administrator account, and
when a payment notification corresponding to the electronic bill is received by the application server, sending a confirmed exchange instruction containing the second user account, the another currency type C2 and the value Z to the blockchain system, in order for the blockchain system to generate, in response to receiving the confirmed exchange instruction, a third transaction record in the blockchain, the third transaction record indicating that Z number of time credits of the another currency type C2 have been added to the second user account, the Z number of time credits having a base time point corresponding to a time point when the third transaction record is generated.

10. The method of claim 9, wherein the identification code contained in the electronic bill is one of a one-dimensional barcode and a two-dimensional barcode.

11. The method of claim 1, the application server being further in communication with a first user-end device and a second user-end device, the plural user identifiers including a second user identifier that corresponds to a user possessing the first user-end device and a third user identifier that corresponds to a user possessing the second user-end device, the plural user accounts including a second user account that corresponds to the second user identifier and a third user account that corresponds to the third user identifier, the method further comprising steps of:
receiving, from the first user-end device, a trade request that contains a value M, the second user identifier, and the third user identifier;
based on the trade request thus received, generating an inquiry request that contains the second user account;
sending the inquiry request thus generated to the blockchain system, in order for the blockchain system to generate, in response to receiving the inquiry request, balance information based on all transaction records in the blockchain that are associated with the second user account and to send the balance information to the application server, the balance information including a base time point of each time credit In the second user account, the base time point of each time credit being related to an expiration time point of the time credit;
after receiving the balance information from the blockchain system, determining, based on the balance information thus received, whether a number of those of time credits in the second user account, the expiration time point of each of which is not before a current time point, is not less than the value M;
when it is determined that the number of those of the time credits in the second user account is not less than the value M, generating a trade instruction containing the value M, the second user account, and the third user account; and
sending the trade instruction thus generated to the blockchain system, in order for the blockchain system to generate, in response to receiving the trade instruction, a second transaction record in the blockchain, the second transaction record indicating that M number of time credits have been moved from the second user account to the third user account.

12. The method of claim 11, wherein the step of sending the trade instruction includes:
sending the trade instruction thus generated to the blockchain system, in order for the blockchain system to generate, in response to receiving the trade instruction, the second transaction record including a first record that indicates that M number of time credits have been removed from the second user account, and a second record that indicates that M number of time credits, each of which has a base time point corresponding to a time point when the blockchain system receives the trade instruction, have been added to the third user account.
